(19) United States
(12) Patent Application Publication
(10) Pub. No.: US 2004/0188530 A1
(43) Pub. Date: Sep. 30, 2004

(54) Removable media housed in a credit card form factor

(76) Inventors: Bert D. Cook JR., Morgan Hill, CA (US); Derek E. Yeo, San Jose, CA (US); Kenneth Zones, Roseville, CA (US); Harry Zones, Citrus Heights, CA (US)

Correspondence Address: Kevin D. Jablonski, #140, 218 Main St., Kirkland, WA, 98033, US

(21) Appl. No.: 10/800,601

(22) Filed: Mar. 15, 2004

Related U.S. Application Data
(60) Provisional application No. 60/456,633, filed on Mar. 24, 2003.
(60) Provisional application No. 60/496,578, filed on Aug. 21, 2003.

(51) Int. Cl. G06K 5/00; G06K 7/00; G06F 1/16

(52) U.S. Cl. 235/486; 235/380

(57) ABSTRACT

A system and method for using a credit card form factor having a removable media stored therein. The credit card form factor comprises a housing having an upper portion and a lower portion; the first and second portions attached to each other such that an enclosure is formed that may be accessed by manipulating at least one of the portions. The housing forms an enclosure for storing a removable media, such as a flexible magnetic media or optical disk. The media is operable to store data in a digital format thereon. When used in a system, the removable media may be removed from the credit card form factor and data stored thereon may be manipulated. As such, a large amount of data can be stored on the removable media, yet still be protected inside the credit card form factor when being transported.

### CROSS REFERENCE TO RELATED APPLICATIONS

This application claims priority from U.S. Provisional Application 60/456,633 titled, “REMOVABLE READ/WRITE MEDIA IN A CREDIT CARD FORM FACTOR,” which was filed on Mar, 24, 2003, and from U.S. Provisional Application 60/496,578 titled, “METHOD AND APPARATUS FOR ACCESSING REMOVABLE MEDIA IN A CREDIT CARD FORM FACTOR,” which was filed on Aug. 8, 2003, both of which are incorporated by reference.

### TECHNICAL FIELD OF THE INVENTION

The present invention relates, generally, to the field of data storage and retrieval and more specifically, the present invention relates to a system and method directed to the storage and retrieval of data on a media housed by credit card form factor.

### BACKGROUND OF THE INVENTION

The capability of storing a large amount of data in smaller media has become prevalent in modern society. DVD-ROMs, CD-ROMs, cell phones, portable hard-drives, and the like provide an individual with the means to store, transport, and retrieve large amounts of useful personal or other data simply by interfacing a system capable of reading from these forms of media. Such data that would be very useful to carry at all times include one's medical/dental history, next of kin contact data, personal banking data, and/or family history and information. Furthermore, because desires to carry this media readily at all times, it proves convenient to store this information in such a media that is durable, robust, low-cost, and small enough to fit into a pocket or one's wallet or purse.

As such, a media in a credit card form factor (a standard for shape, thickness, and flexibility of the credit card) provides a convenient and popular way to store, transfer and transport data.

In the past, one way in which data has been stored on a credit card form factor is by using a magnetic strip on the outside. In this well-known way, a magnetic strip is used to store a limited amount of data that typically included one's identification by name and an account number. When “swiped” in a credit card reader, the data may be retrieved. This system and method has proven useful for a limited amount of data, but is not practical for storing larger amounts of data. Further, there is no practical way to add or change the data once written to the magnetic strip. Additionally, the data is vulnerable to corruption in that the magnetic strip is exposed and often becomes compromised or damaged through physical use of the credit card or by stray magnetic fields near the credit card.

Another solution of the past has been to use an integrated circuit(C) chip embedded in the credit card form factor. Using this system and method, data described above may be stored in a memory within the IC chip. Although, this solution provides a nominal amount of additional space for storage, it is still not enough memory space to store much more useful data, such as financial history, family and/or medical records and the like. Further, the IC chip is still exposed and may be data stored therein may still be compromised through typical use. Additionally, in order to read data from the IC chip, one needs an interface capable of interacting with the IC chip and retrieving the data in a known manner. Although, not difficult to implement, IC chip readers are not as prevalent as readers capable of retrieving data from a magnetized media, such as a magnetic strip or a hard disk.

Thus, it would be quite advantageous to have the capability of storing a large amount of data (greater than 40 megabytes) in a media that is on or within a credit card form factor that proves to be physically robust and fault tolerant.

### SUMMARY OF THE INVENTION

In one embodiment, the present invention is directed to a credit card form factor having a removable media stored therein. The credit card form factor comprises a housing having an upper portion and a lower portion; the first and second portions attached to each other such that an enclosure is formed that may be accessed by manipulating at least one of the portions. The housing forms an enclosure for storing a removable media, such as a flexible magnetic media or optical disk. The media is operable to store data in a digital format thereon. When used in a system, the removable media may be removed from the credit card form factor and data stored thereon may be manipulated. As such, a large amount of data can be stored on the removable media, yet still be protected inside the credit card form factor when being transported.

In another embodiment, the present invention is directed to an apparatus for engaging a credit card form factor having a removable media. The apparatus comprises an interface operable to receive a credit card form factor having a removable media enclosed by a housing, a media-drive assembly operable to receive the credit card form factor and operable to remove the removable media from the housing, the media-drive assembly controlled by a controller, and a media drive operable to access data on the removable media. Thus, the removable media may be accessed, data read from it, and then replaced back in the credit card form factor for transport and later use.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows an exploded view a credit card form factor having a removable media enclosed therein according to an embodiment of the invention;

FIG. 2 shows another exploded view of a credit card form factor having a removable media enclosed therein according to an embodiment of the invention;

FIG. 3 shows an isometric view of an assembled credit card form factor of FIG. 1 according to an embodiment of the invention;

FIG. 4 shows a diagram of a system for using a removable media housed in a credit card form factor according to an embodiment of the invention;

FIG. 5 shows a block diagram of a controller within the terminal device of FIG. 4 for controlling the media drive assembly according to an embodiment of the invention;

FIG. 6 shows an isometric view of various components of a media-drive assembly within the terminal device of FIG. 4 according to an embodiment of the invention;

FIGS. 7A-7H show a step-by-step representation of the overviewed process described with respect to FIG. 6 according to an embodiment of the invention; and

FIG. 8 shows a flow chart of a method for manipulating a credit card form factor having a removable media and for storing data on and/or retrieving data from a removable media stored in a credit card form factor according to an embodiment of the invention.

### DETAILED DESCRIPTION

The present invention is directed to a system and method for using a removable media in a standard credit card form factor. A standard credit card form factor is a well-known term in the industry that refers to the typical parameters associated with common credit cards. For example, a typical credit card will have specific dimensions for width, length, and thickness. Further, the flexibility of the card itself is another parameter associated with a credit card form factor. These typical parameters have been standardized by the International Standards Organization in ISO/IEC 7810-7811. As such, the term credit card form factor, as used herein, embodies a card that strives to meet with the ISO standards. However, the underlying methods of the invention need not necessarily be practiced in the form of a credit card form factor as will become apparent throughout this disclosure. For example, the thickness of a credit card form factor according to some embodiments of the present invention may be greater (between 30 and 90 mils) than the ISO standard (which is 30 mils or less) in order to accommodate the removable media enclosed by the credit card form factor.

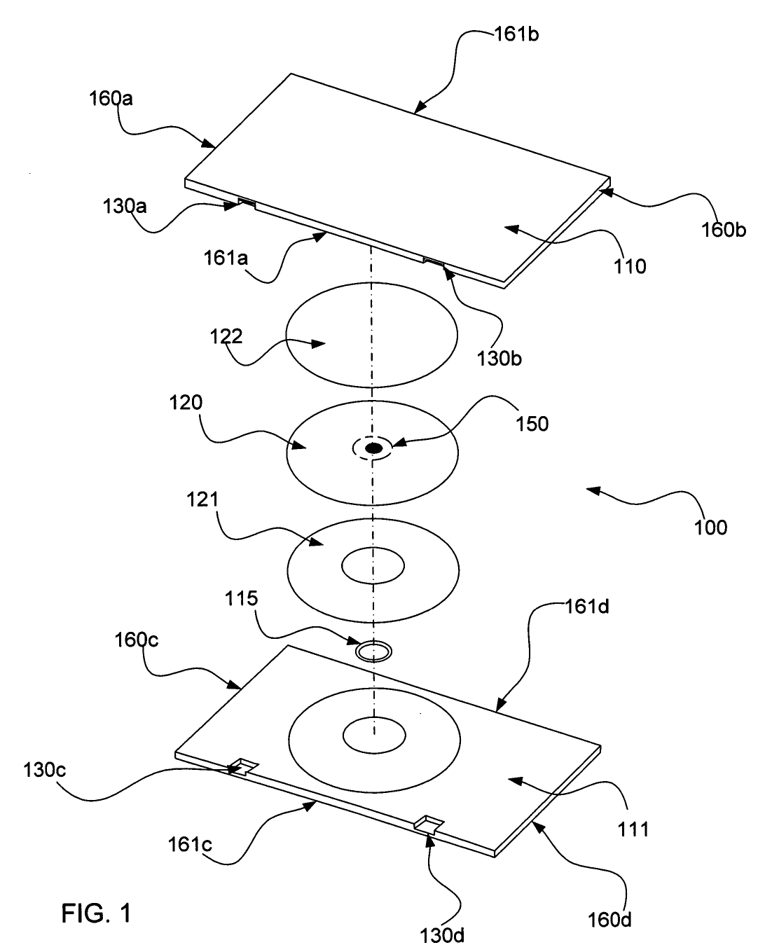

FIG. 1 shows an exploded view of a credit card form factor having a removable media enclosed therein by a housing according to an embodiment of the invention. In this embodiment, a credit card form factor, referred to as a media sleeve 100 throughout this disclosure, includes a removable media 120 enclosed by two portions, an upper portion 110 and a lower portion 111 of the media sleeve 100. Typically, the upper portion 110 and the lower portion 111 will have the same topographical features in order to accommodate the other pieces (described below) within the media sleeve 100. However, the portions 110 and 111 may be of any size, shape and design, not necessarily similar to each other, such that the removable media 120 is still enclosed.

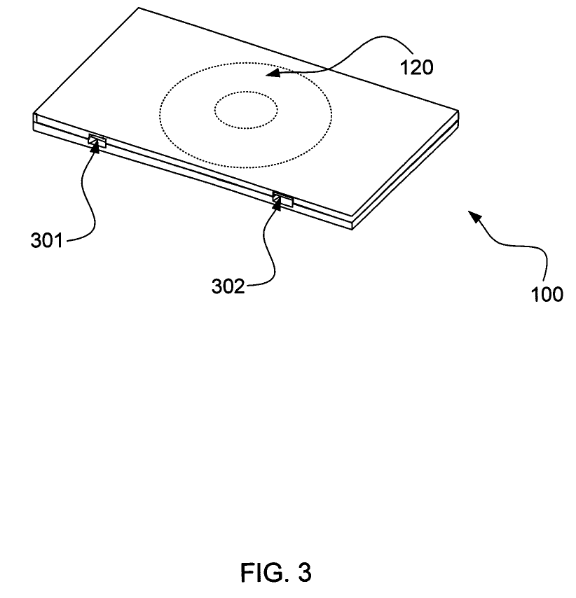

Each portion, the upper portion 110 and the lower portion 111, of the media sleeve 100 includes depressions 130a-d. The depressions 130a-d are located along one of the long sides 161a/c of the media sleeve 100 and are disposed closer to the outer edges of the long sides 161a/c of each portion 110 and 111 as shown in FIG. 1. The locations of the depressions 130a-d are the same for both the upper portion 110 and the lower portion 111 such that when the media sleeve 100 is assembled, the depressions 130a-d align with each other. That is, the first depression 130a on the upper portion 110 aligns with the first depression 130c on the lower portion 111 and the second depression 130b on the upper portion 110 aligns with the second depression 130d on the lower portion 111. When the media sleeve 100 is assembled (shown below in FIG. 3), the pairs of depressions 130a/c and 130b/d form holes (301 and 302 in FIG. 3) that are used during a media extraction process described below. In another embodiment, additional pairs of depressions (not shown) may be located on the other long side 161b/d of the media sleeve 100 such that the extraction process (again, described below) may be accomplished from either long side 161a/c or 161 b/d of the media sleeve 100. Further, other pairs of depressions (not shown) may be on either short side 160a/c and/or 160 b/d of the media sleeve 100 such that the extraction process may occur from the short sides as well. As described herein, only one side having depressions 130a-d will be shown for example.

The removable media 120 is typically a flexible magnetic media capable of storing at least 40 Megabytes of data. In other embodiments, the removable media 120 is another type of read/write storage such as a magnetic media sputtered on glass, ceramic, film, or metal or some form of optical media. The removable media 120 typically needs to be protected from being scratched or dented by small rocks and dust particles (or anything that may damage the removable media 120) that may come into contact with the removable media 120. As such two protective pads, an upper protective pad 122 and a lower protective pad 121, are disposed within the media sleeve 100 such that both faces of the removable media 120 only come into contact with the protective pads 121 and 122 when enclosed in the media sleeve 100. In one embodiment, the protective pads 121 and 122 are made of non-woven cloth.

A magnetic ring 115 is attached to the lower portion 111 of the media sleeve 100. The function of the magnetic ring 115 is to center the removable media 120 and to hold it in place when enclosed by the media sleeve 100. A typical removable media 120 will have a center hub 150 that is made of a magnetic material and that has a chamfered edge. As such, when the removable media 120 is enclosed in the media sleeve 100, the magnetic ring 115 attracts and holds the hub 150 of the removable media 120 and keeps the removable media 120 securely in a centered position of the media sleeve 100.

When the media sleeve 100 is assembled, the short sides 160a-d of the media sleeve 100 come together such that side 160a aligns with side 160c and side 160b aligns with side 160d. When assembled, the aligned short sides 160a/c and 160b/d are attached to each other such that they are prevented from separating. However, the aligned long sides 161a/c and 161b/d are not attached and may be separated (by bending open like a “media sleeve”) by a force. Alternatively, one of the long side pairs 161b/d may be attached to each other just like the short sides 160a/c and 160 b/d such that the long side pair 161b/d is also prevented from separating. Further, the long sides 161a/c and 161b/d may be attached and the short sides 160a/c and 160b/d unattached for opening and retrieval.

In order to maintain the media sleeve 100 in a “closed” position once assembled (i.e., the long sides 161a-d remain adjacent to each other, but not attached to each other such that the removable media 120 cannot be removed) the upper portion and lower portion are typically fabricated with a bias to a specific position. That is, the upper portion 110 and the lower portion 111 are each biased to a closed position but are flexible in accordance with typical standards for a credit card form factor. Thus, the media sleeve 100 when assembled may bend in any direction but will be biased to return to the original, biased, closed position. The long sides 161a-d remain unattached to each other so that the removable media 120 may be removed when one of the long sides 161a/c or 161b/d are separated via bending to form an opening. That is, the upper portion 110 long side 161a may be bent upward and the lower portion 111 long side 161c may be bent downward creating an opening to extract the removable media 120.

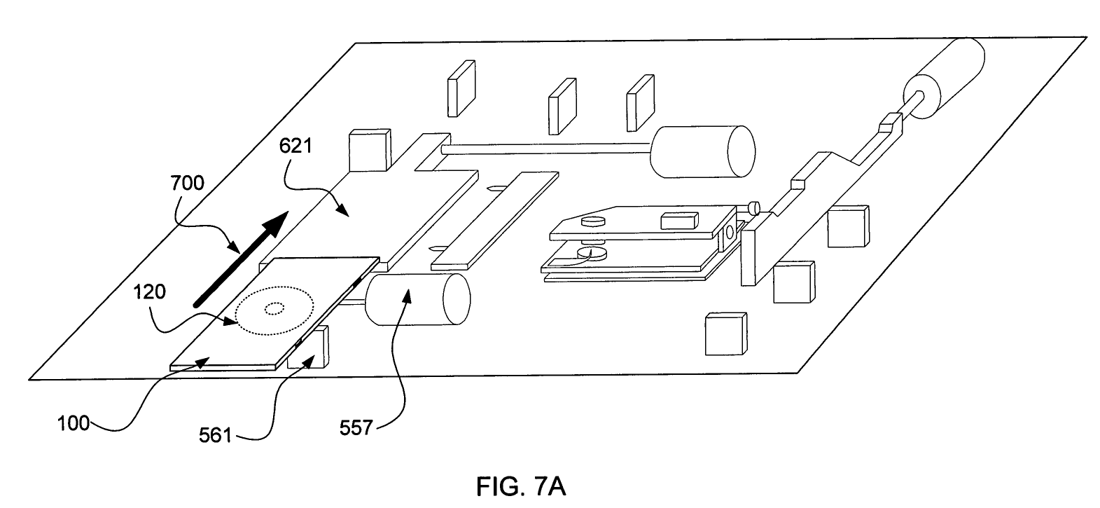

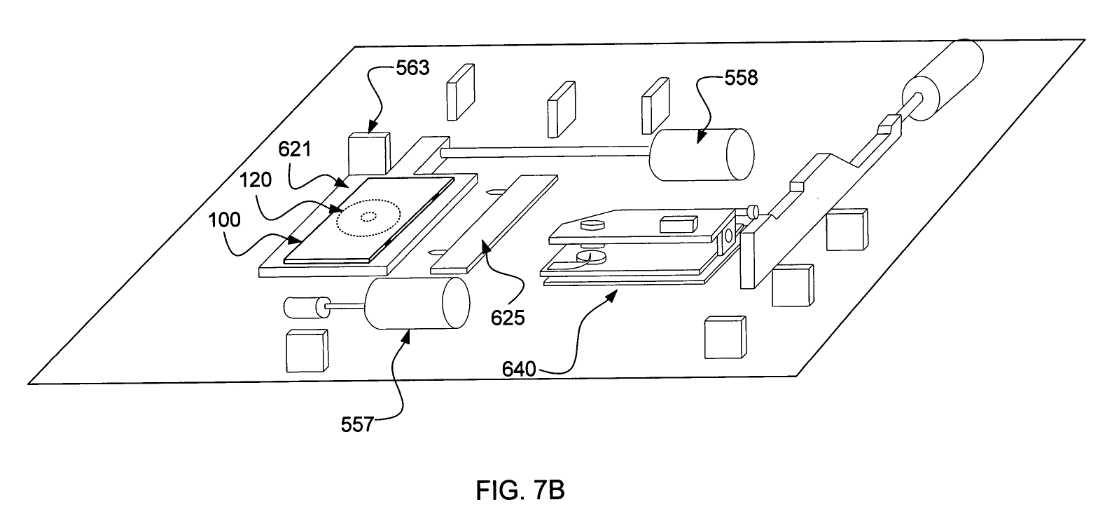

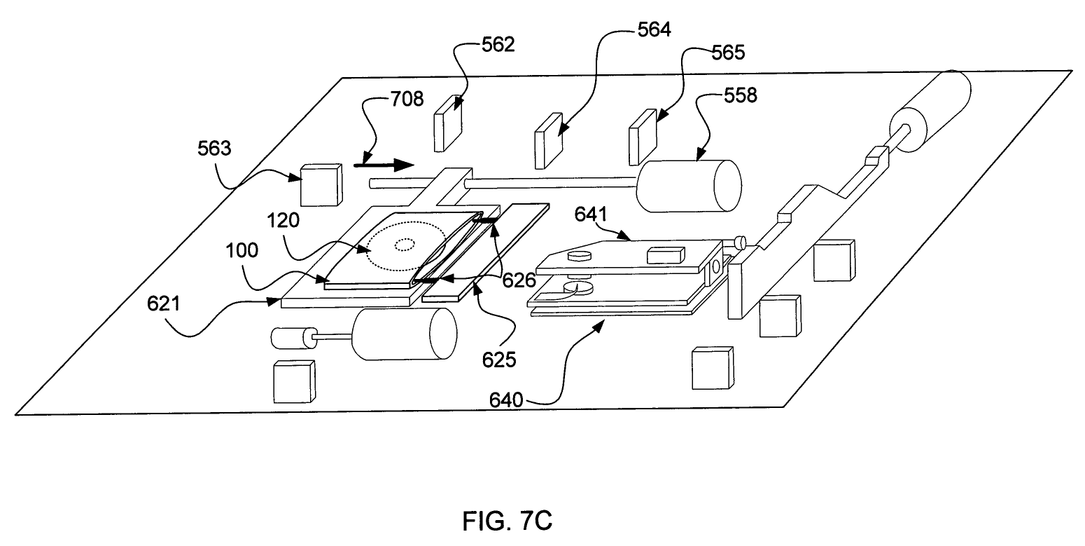

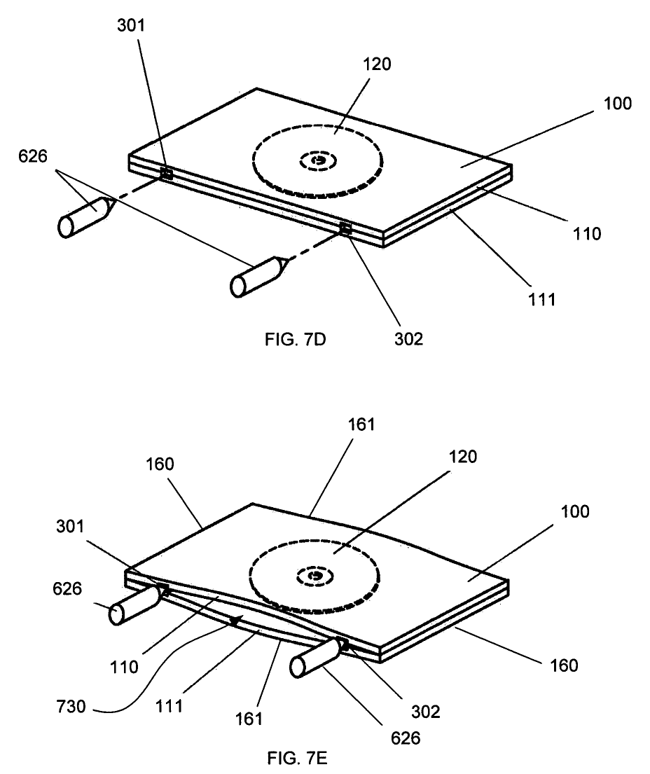

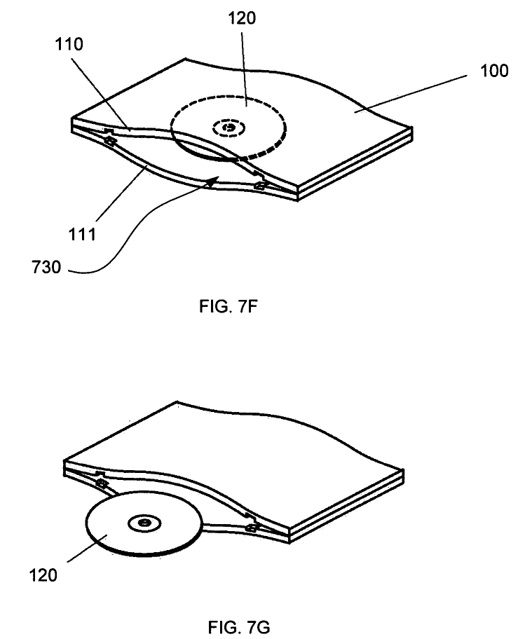

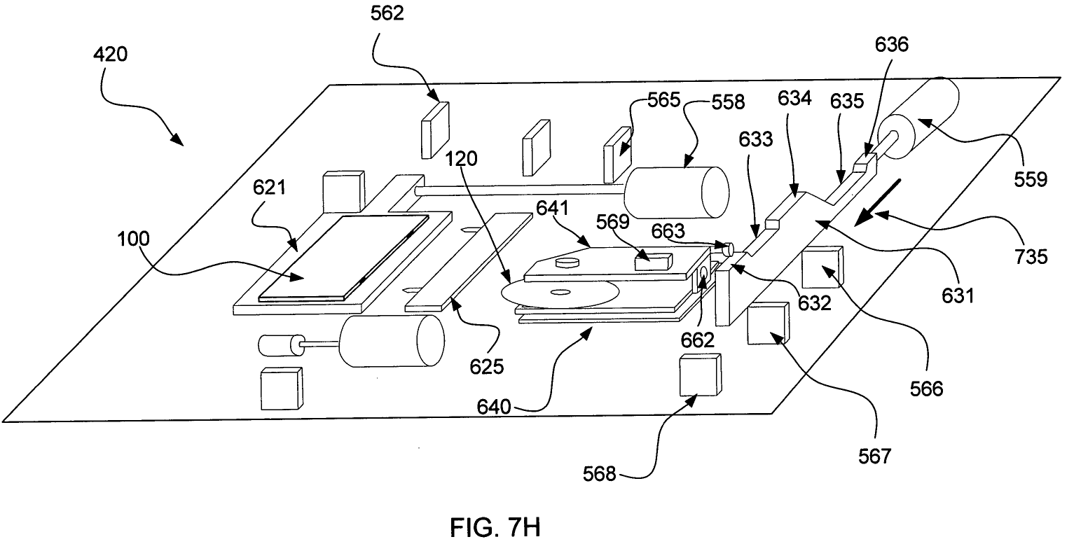

In yet another embodiment, the upper portion 110 and lower portion 111 may even be fabricated to have a slight bend in the opposite direction of bending direction when opening. Although not shown in the figures, the upper portion 110 may have a slight curve such that the short sides 160a and 160b are raised slightly with respect to the center. The lower portion may also have a slight curve in a similar fashion albeit in the opposite direction. As such, when assembled, the media sleeve 100 seals all the more tightly along its long sides 161a-d because of the biasing imparted to the upper and lower portions 110 and 111. This will become more apparent when discussed below in conjunction with FIGS. 3 and 7A-7H.

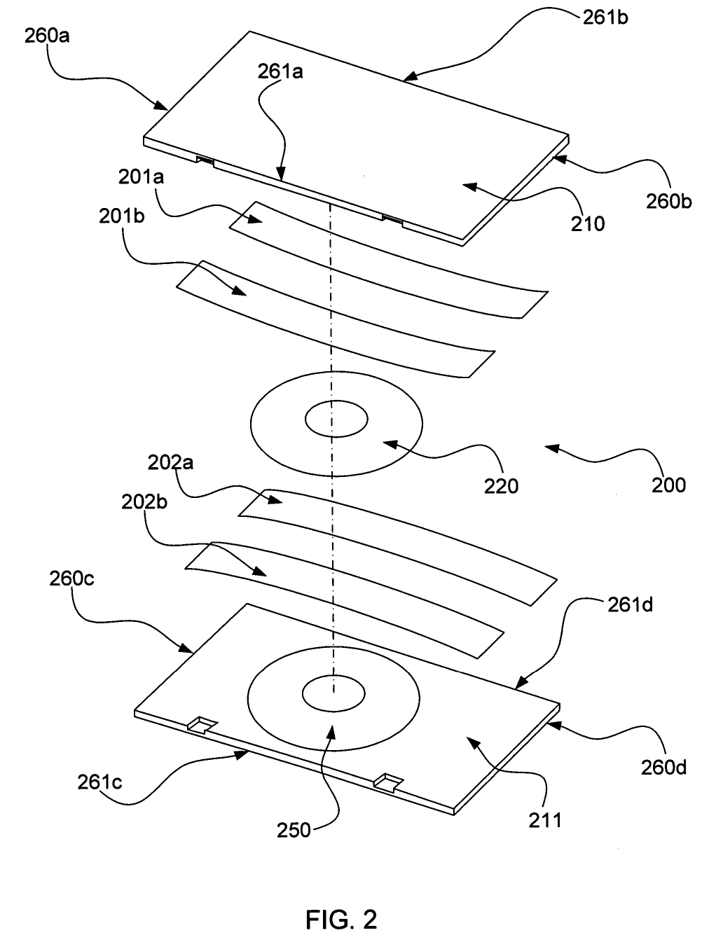

FIG. 2 shows another exploded view of a credit card form factor having a removable media 220 enclosed therein according to an embodiment of the invention. In this embodiment, biased springs 201 and 202, typically comprised of stainless steel, are also enclosed within the media sleeve 200. Further, the removable media 220, the protective pads (not shown in FIG. 2 for clarity) and the magnetic ring (also not shown in FIG. 2) may be housed within the media sleeve 200. The biased springs 201a-b and 202a-b engage each respective upper/lower portion 210 and 211 in such a way as to apply a force tending to maintain the closed position of each respective portion 210 and 211 of the media sleeve 200. That is, the two springs 201a-b engaging the upper portion 210 are biased such that a force is applied outward to each short side 260a and 260b. When the upper portion 210 is bent upward (during the extraction process), the distance between the short sides 260a and 260b becomes less and the force exerted by the biased springs 201a-b against the respective short sides 260a and 260b becomes greater. As such, in a closed position, the biased springs 201a-b and 202a-b help maintain the closed position of the upper portion 210 when not involved in an extraction process. The lower portion 211 and associated engaged springs 202a-b are configured in a similar manner and behave accordingly similar albeit in an opposite configuration so as to complement the upper portion 110.

Further, the combination of forces exerted by the biased springs 201a-b and 202a-b on the short sides 260a-d of the media sleeve 200 tend to force the long sides 261a-d to seal tightly closed. As a result, the tight seal prevents moisture and particulates from getting inside the media sleeve 200 that may damage the removable media 220. Further, an additional sealing mechanism (not shown) may provide additional protection from moisture and particulates getting inside the media sleeve 200. For example, the sealing mechanism may include formed grooves that interface to form a more protective seal. Alternatively, the sealing mechanism may be magnetic.

The interior topography of the upper portion 210 and the lower portion 211 may also be such that recesses, such as media recess 250, help align the various pieces within the media sleeve 200. The biased springs 201a-b and 202a-b may also have recesses (not shown for clarity) that help align the biased springs 201a-b and 202a-b within the media sleeve 200.

FIG. 3 is an isometric view of an assembled media sleeve 100 of FIG. 1 according to an embodiment of the invention. As can be seen, the depressions 130a-d described above with respect to FIG. 1, have come together to form holes 301 and 302. Again, in some embodiments, an additional set of depressions (not shown) may also be located on the other long side of the media sleeve 100 or on one of the short sides. The holes 301 and 302 allow pins (not shown in FIG. 3) to open the media sleeve 100 during an extraction process. The removable media 120 is shown by hidden lines in FIG. 3 as it is located inside the media sleeve 100. An extraction process is described below with respect to FIGS. 7A-7H.

The media sleeve 100 may also have many conventional features of a typical credit card. Although not shown in the figures, one may appreciate that a photo ID may appear on the outside of the media sleeve 100. Further, an IC chip (contact and/or contactless) may be embedded in the media sleeve 100 along with related circuitry and contacts. Still further, a magnetic strip having data stored thereon may also be disposed on the outside of the media sleeve 100. Still further yet, additional information in the form of a bar code stamped onto the media sleeve or the owner's name and standard credit card number may be stamped onto the media sleeve 100. In essence, any conventional feature of a typical credit card may be incorporated into the media sleeve 100 of FIG. 3.

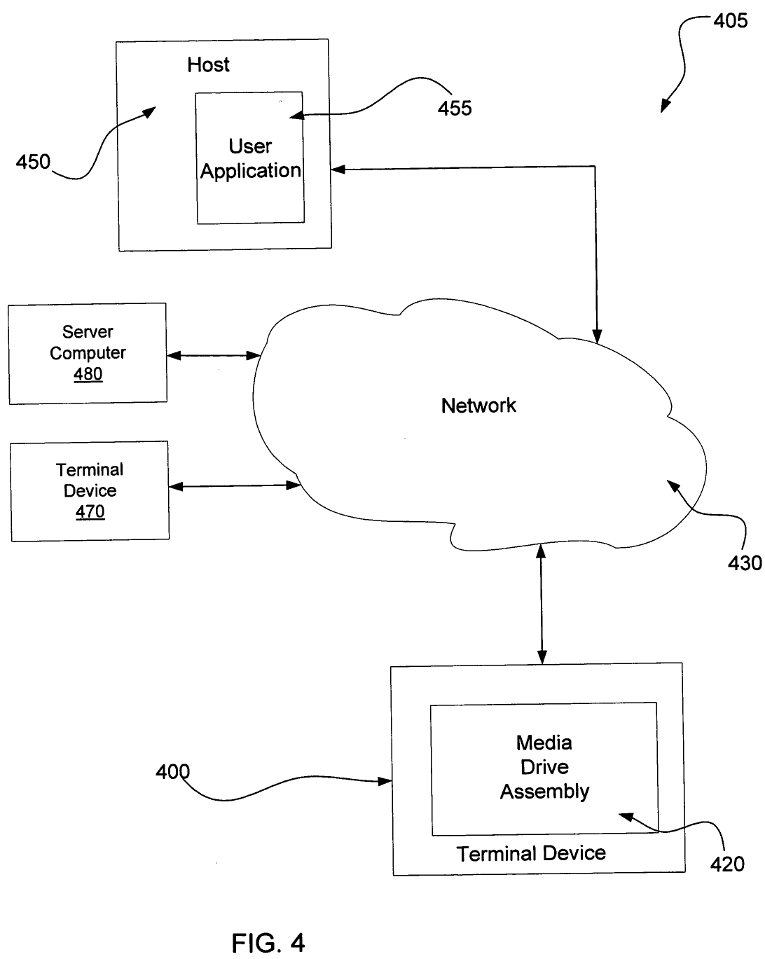

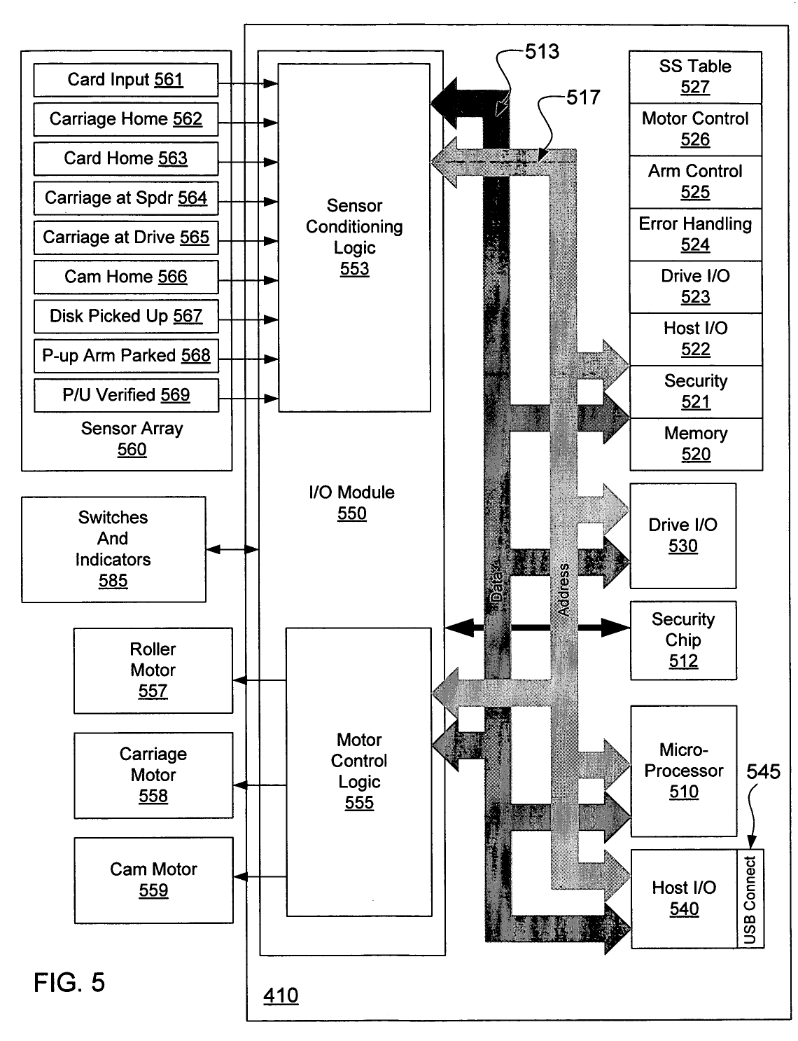

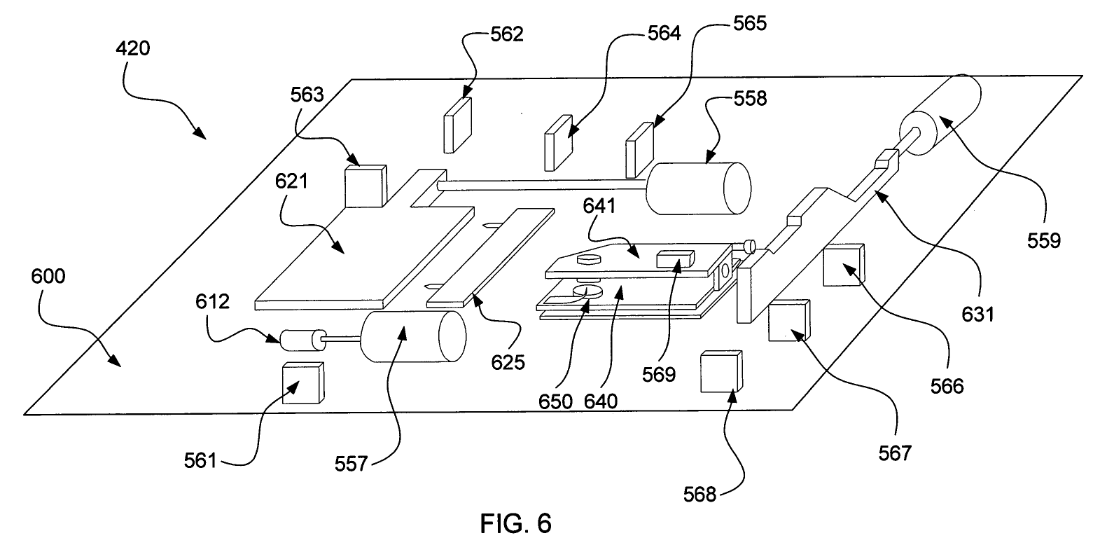

FIG. 4 shows a diagram of a system for using the credit card form factor of FIG. 1 according to an embodiment of the invention. The system 405 includes a terminal device 400 that is configured to interface with a removable media 120 enclosed in a credit card form factor. The media sleeve 100 described above with respect to FIGS. 1-3 may be used in conjunction with the terminal device 400 such that the removable media 120 may be accessed to retrieve data from or store data to the removable media 120. The terminal device 400 shown in FIG. 4 includes a media drive assembly 420 that is configured to control the manipulation of both the media sleeve 100 and the data stored on the removable media 120 once the removable media 120 has been extracted from the media sleeve 100. Specific aspects of the media drive assembly 420 are described in greater detail below in FIGS. 5 and 6, respectively.

In this embodiment, the terminal device 400 is connected to a network 430 such that a conventional communication component (not shown) having a transmitter and receiver may transmit and receive data from the network 430. The network 430 may be any type capable of passing data between the terminal device 400 and other devices connected to the network 430. For example, the network 430 may comprise a typical Local Area Network (LAN) or a Wide Are Network (WAN). Other devices connected to the network 430 (also having conventional communication components for transmitting and receiving data over a network) may include another terminal device 470, a server computer 480, or a host computer 450 having a user application 455 running thereon. Typically, the user application 455 is configured to use data that may be stored on or retrieved from the removable media 120 at the terminal device 400. Examples of user applications 455 include point-of-sale applications, medical applications, and the like.

Note that while the example shown in FIG. 4 shows a terminal device 400 that is remote from a host computer 450 (and the respective user application 455), it is possible that the user application 455, the host computer 450, and the terminal device 400 may be contained within the same unit. Thus, in some embodiments, the need for the network 430 is eliminated. For example, a ticketing kiosk (not shown) may contain a dedicated host computer 450 running a user application 455 that is connected directly to the terminal device 400 via a universal serial bus (USB) connection.

FIG. 5 shows a block diagram of a controller 410 within a terminal device 400 for controlling the media drive assembly 420 according to an embodiment of the invention. A microprocessor 510 is connected to a data bus 513 and an address bus 517 in a conventional manner. The microprocessor 510 is a conventional microprocessor as is well known in the art, thus, the procedures and operations regarding the microprocessor 510 are not discussed further herein.

A host input/output port 540 is also connected to the data bus 513 and the address bus 517 and provides a means for communication between the microprocessor 510 and a host (such as the host computer 450 of FIG. 4) via a USB connection 545. Using this host I/O port 540, the host computer 450 may pass status and command data back and forth with the microprocessor 510.

The microprocessor 510 is also connected to a drive input/output port 530 via the data bus 513 and the address bus 517. The drive I/O port 530 passes commands and data from the media-drive assembly 420 to the microprocessor 510 and/or the host computer 450 depending on the specific task. For example, when a removable media 120 is loaded into a terminal device 400, the media-drive assembly 420 relinquishes control of the removable media 120 until the microprocessor 510 indicates that the controller 410 is finished reading/writing data on the removable media 120. Thus, control of the removable media 120 is given (via a command through the drive I/O port 530) back to the media-drive assembly 420 so that the removable media 120 may be returned to the media sleeve 100.

Several modules 520-527 contain software and firmware instructions for controlling the various devices and apparatus associated with a typical terminal device 400. Each of these modules 520-527 is connected to the data bus 513 and the address bus 517.

A memory module 520 contains the necessary instructions, in the form of software code, to execute various methods of the present invention (described further below with respect to FIGS. 7A-7H).

A sensor-state-table (SST) module 527 contains the logical code for interpreting the status of sensors (described below with respect to FIG. 6) associated with the media-drive assembly 420.

A motor-control module 526 and arm-control module 525 use the data from the SST module 527 to activate appropriate actions (described below with respect to FIGS. 7A-7H) to manipulate the media sleeve 100 and the removable media 120.

An error-handling module 524 contains instructions that enable the terminal device 400 to initialize upon startup and/or react to abnormal situations (such as no removable media 120 found in a media sleeve 100). Should an error occur during the process, the error-handling module 524 recognizes a deviation from the normal processes and, in response to a particular deviation, causes a corrective action to be taken.

A drive I/O port module 523 contains instructions for interfacing with the media-drive assembly 420 via the previously described drive I/O port 530. Similarly, a host I/O port module 522 contains instructions for interfacing with the host computer 450 via the previously described host I/O port 540.

Finally, a security module 521 contains instructions to interpret and react to data received from an associated security chip 512. The security chip 512 provides a first level of protection for the data stored on a removable media 120. In one embodiment, if an unauthorized attempt is made to use the data on the removable media 120, the security chip 512 in concert with the security module 521 disallows access to the removable media 120. The security chip 512 may be a contact or contactless chip embedded in the media sleeve 100.

The controller 410 also includes an Input/Output module 550 that contains hardware and logic for interfacing with components in the media-drive assembly 420. The I/O module 550 includes sensor conditioning logic 553 that accepts command and control signals from the data bus 513 and the address bus 517. Additionally, various sensor signals 561-569 (shown in FIG. 5 for illustrative purposes as the sensors themselves are located throughout the terminal device 400) are part of a sensor array 560 that receives input events during the operation of the media-drive assembly 420. These signals are conditioned in a conventional manner and are manipulated by the command and control signals such that the SST module 529 is continuously updated with the current status of each of the sensors 561-569.

The I/O module 550 also includes motor control logic 555 that also accepts command and control signals from the data bus 513 and the address bus 517. The motor-control logic 555 passes these control signals to the appropriate motors 557-559 (again, shown in FIG. 5 for illustrative purposes as the motors themselves are located throughout the terminal device 400) in a conventional manner depending on which specific motor is to be activated.

Finally, other switches and indicators 585 provide numerous conventional functions. For example, a reset switch (not shown) may be used to recover from an error. Other functions may include a display indicator, a numeric keypad, and/or other switches and indicators depending on the specific type of application and hardware configuration. Since these switches and indicators along with their related functions are well understood in the art, they are not discussed in any further detail herein.

FIG. 6 shows an isometric view of various components of a media-drive assembly 420 within the terminal device 400 of FIG. 4 according to an embodiment of the invention. The various components are shown disposed on a base 600 that may the base of an enclosure, a circuit board, or any other base upon which the various components can be anchored for use. For ease of illustration, anchor supports, wiring leads, wiring traces, external enclosure walls, and other extraneous devices and parts are not shown so that the operation of the media-drive assembly 420 can be more readily shown. Further, the particular arrangement of the various components is also for illustrative purposes only and should not be read as a limitation on the scope of the invention.

The components of the media-drive assembly 420 operate in concert with the controller 410 (not shown in FIG. 6) to receive a media sleeve 100 having a removable media 120, to remove the removable media 120 from the media sleeve 100 and to place the removable media 120 on the media drive 640 for read and write operations. By way of overview, the operation of the media-drive assembly 420 is described briefly with respect to the motors 557-559 in the media-drive assembly 420. A more detailed description of the process follows in a discussion of FIGS. 7A-7H.

The media-drive assembly 420 includes three motors 557-559, each having sensors and components for manipulating the media sleeve 100 and/or the removable media 120. First, a rollor motor 557 operates to receive and eject the media sleeve 100 from an insert slot (not shown) on the terminal device 400. When a media sleeve 100 is inserted, a card-input sensor 561 detects the presence of the media sleeve 100 and provides input to the controller 410 to turn on the roller motor 557. A roller 612 engages the media sleeve 100 and pulls the media sleeve 100 into the terminal device 400 until the media sleeve 100 comes to rest in a fully inserted position on a carriage assembly 621. The roller motor 557 stops when a card home sensor 563 detects that the media sleeve 100 is fully inserted on the carriage assembly 621.

Second, a carriage motor 558 operates to maneuver the carriage assembly 621 (via a well-known thread-screw technique) now having the media sleeve 100 thereon, toward a spreader 625 and a media drive 640 and away from a carriage-home sensor 562 Once the carriage assembly 621 has reached the spreader 625 and the spreader 625 has opened the media sleeve 100, a carriage-at-spreader sensor 564 is actuated and the carriage assembly 621 and spreader 625 are then moved (now in tandem) toward the media drive 640 so the removable media 120 may be extracted.

Third, a cam motor 559 is actuated when the carriage-at-drive sensor 565 detects that the carriage assembly 621 and spreader 625 tandem has reached the media drive 640. This causes a pick-up arm 641 (actuated by a cam assembly 631) to engage the removable media 120. Then sensors 566 to 569 work in concert with the cam assembly 631 and cam motor 559 to place the removable media 120 on the spindle 650 of media drive 640.

The media drive 640 may then use the removable media 120 in a conventional manner. When finished, the process operates in reverse as the removable media 120 is placed back in the media sleeve 100 and then ejected from the terminal device 400. Each of the preceding processes is described in greater detail below.

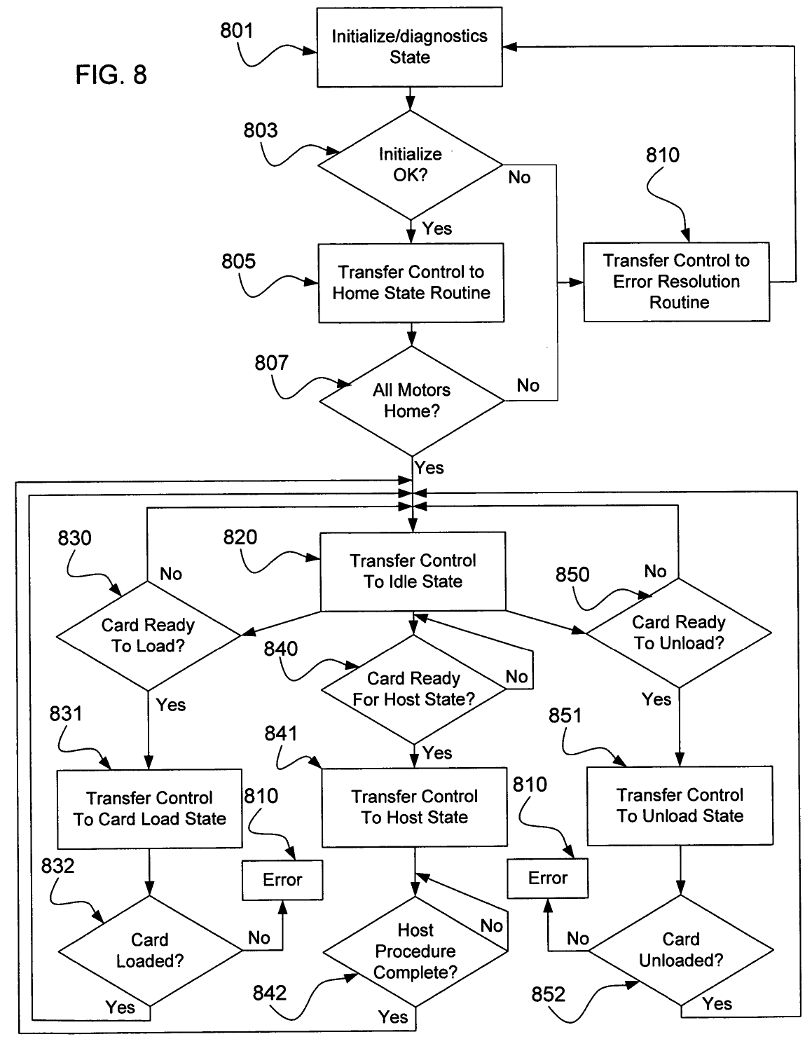

FIGS. 7A-7H show a step-by-step representation of the overviewed processes described above with respect to FIG. 6 according to an embodiment of the invention. Only the physical movements of the method and the associated components are discussed in these figures to aid in clarity. As such, specific ancillary details, for example, media drive 640 operations or user interface operations have been omitted. The process of various methods of the present invention is discussed below in conjunction with FIG. 8. Note further, that the loading procedure is discussed in detail while the unloading procedure is not. It will be understood that the unloading procedure is effectively the reverse of the loading procedure.

Beginning with FIG. 7A, a media sleeve 100 containing a removable media 120 is placed at an insert slot (not shown as the insert slot is part of the external enclosure) of the terminal device 400. The card input sensor 561 detects the presence of the media sleeve 100 and causes the roller motor 557 to activate in a clockwise direction, turning the roller 612 (which cannot be seen because it is underneath the media sleeve 100 in FIG. 7A). The media sleeve 100 which is engaging the roller 612 then moves along the direction indicated by arrow 700 toward the carriage assembly 621.

FIG. 7B shows the media sleeve 100 situated on the carriage assembly 621 and, thus, ready to be moved toward the media drive 640. The roller motor 557 remains activated until the card home sensor 563 detects that the media sleeve 100 is fully loaded onto the carriage assembly 621. As can be seen in FIG. 7B, the media sleeve 100 is completely at rest on the carriage assembly 621. Now, the next step of the procedure, i.e., retrieval of the removable media 120 from the media sleeve 100, may begin. As such, the carriage motor 558 is activated and the carriage assembly 621 begins moving toward the spreader 625.

FIG. 7C shows the media sleeve 100 being opened by the spreader 625. This part of the procedure begins when the carriage motor 558 is activated causing the carriage assembly 621 (with the loaded media sleeve 100) to move toward the spreader 625 in the direction indicated by arrow 708. The carriage motor 558 continues to run until the carriage-at-spreader sensor 564 detects that the carriage assembly 621 has reached the spreader 625. When this occurs, the media sleeve 100 is opened by the spreader pins 626, each pin aligning with the holes (301 and 302 of FIG. 3) formed on one side of the media sleeve 100. This spreading procedure for opening the media sleeve 100 is described in greater detail in FIGS. 7D-7G, in the following paragraphs. For now, once the media sleeve 100 is opened, the carriage assembly 621 (with the still loaded, but now open media sleeve 100) and the spreader 625 move, in tandem, toward the media drive 640 until the carriage-at-drive sensor 565 detects that carriage assembly 621 is positioned such that the pick-up arm 641 of the media drive 640 is directly over the removable media 120. At this point, the carriage motor 558 is deactivated.

In one embodiment, when the carriage assembly 621 is moving toward the spreader 625, a carriage-at-spreader detects that the carriage assembly 621 has reached the spreader 625. At this point, the pins 626 of the spreader 625 begin to open the media sleeve 100. However, prior to completely opening the media sleeve, a release (not shown) releases the spreader 625 from an anchored position. This allows the spreader 625 to move, in tandem, with the carriage assembly 621 until the spreader 625 is stopped by a stopper (also not shown) near the media drive 640. The carriage motor 558 remains activated and the carriage assembly 621 is driven further into the pins 626 of the spreader 625 such that the media sleeve 100 opens up to a completely open position. Additionally, the pickup arm 641 is enveloped by the opening at this point. Prior to discussing the process of engaging and extracting the removable media 120, a more detailed description of the interaction of the media sleeve 100 with the spreader 625 is presented.

Turning to FIGS. 7D-7G, which show the removable media extraction process in greater detail, only the media sleeve 100 and the spreader pins 626 are shown for ease of illustration. In FIG. 7D, as the media sleeve 100 approaches the spreader pins 626, it can be seen that the holes (301 and 302 described previously with respect to FIG. 3) are aligned with the respective spreader pins 626. As can also be seen, the upper portion 110 and the lower portion 111 of the media sleeve 100 are still closed together and sealed.

In FIG. 7E, the media sleeve 100 engages the spreader pins 626 (i.e., the spreader pins 626 enter the holes 301 and 302). Forces are exerted on both the upper portion 110 and the lower portion 111 of the media sleeve 100 such that the media sleeve “opens up.” That is, the upper portion 110 bends (because it is formed from a flexible material) upward and the lower portion 111 bends downward to create an opening 730 between the upper portion 110 and the lower portion 111. As previously discussed with respect to FIG. 1, the short sides 160 of the media sleeve 100 are attached to each other whereas the long sides 161 are not (or at least the long side with the holes 301 and 302). Thus, the long sides 161 may open up when the spreader pins 626 force the upper portion 110 and the lower portion 111 apart.

In FIG. 7F, as can be more easily seen, (because the spreader pins 626 have been removed from the illustration for clarity), the opening 730 is formed when the upper portion 110 and the lower portion 111 of the media sleeve 100 have been spread apart. As such, a pick-up arm (not shown here) or other mechanism for retrieving the removable media 120 may enter the opening 730 in order to engage the removable media 120.

In FIG. 7G, once the removable media 120 is engaged by a retrieval device (still not shown for clarity), the removable media 120 may be removed from the media sleeve 100 for use in the media drive 640 (also not shown here).

FIG. 7H again shows a larger overview of the media-drive assembly 420 now at a final stage such that the removable media 120 has been extracted and is ready to be accessed by the media drive 640. Returning to the same point in the previous discussion of the extraction procedure, prior to the discussion of FIGS. 7D-7G, the carriage assembly 621 with the opened media sleeve 100 is maneuvered to a position at the media drive 640 as detected by the carriage-at-drive sensor 565. At this point (which is not illustrated in FIG. 7H), the carriage motor 558 is deactivated as the media sleeve 100 is positioned such that the pick-up arm 641 is inside the opening 730 (as shown in FIG. 7F) of the now spread apart media sleeve 100. Thus, the pick-up arm 641 is positioned over the removable media 120 such that it is ready to engage the hub 150 of the removable media 120.

The pick-up arm 641 may be raised or lowered in a vertical direction by being actuated by the cam assembly 631 which is actuated by the cam motor 559 (again, in a well-known thread-screw technique). The cam assembly 631 includes five levels 632-636 that engage a roller 663 attached to the pick-up arm 641. Based on the level of the cam assembly 631 that the roller 663 of the pick-up arm 641 is resting on, the entire pick-up arm 641 may be raised or lowered accordingly. The five levels include a pick-up-arm-home level 632, a disk-grab level 633, a pick-up-arm-up level 634, a disk-on-spindle level 635 and a pick-up-arm-parked level 636.

As the cam motor 559 moves the cam assembly 631 in the direction indicated by the arrow 735, the cam-at-home sensor 566 is de-actuated and the position of the pick-up arm 641 changes according to the corresponding level. As can be seen, at the cam-assembly-home level 632, the pick-up arm 641 is at its highest level. Then, as the cam assembly 631 moves along the direction indicated by arrow 735, the pick-up arm 641 lowers to the disk-grab level 633 such that the pickup arm 641 may grab the removable media 120.

At this point, the pick-up arm 641 engages the hub 150 of the removable media 120. In one embodiment, the pick-up arm 641 includes microfingers (not shown in detail) that may be actuated to spread apart when at the disk-grab level 633 such that the hub 150 of the removable media 120 is engaged. The surface of the cam assembly 631 which faces the media drive 640 is contoured such that a detent ball 662 is actuated which causes the microfingers to spread apart to engage the hub 150 of the removable media 120. A pick-up-verified sensor 569 is actuated if the removable media 120 has been successfully engaged. If the pick-up-verified sensor 569 is not actuated, the procedure loops several times until successful and the removable media 120 is properly engaged by the pick-up arm 641. That is, the cam motor 559 reverses the cam assembly 631 back to the cam-assembly-home level 632 and then moves the cam assembly 631 forward again (thus, un-engaging and re-engaging the detent ball 662) until the pick-up is verified.

Once the removable media 120 is engaged and the pick-up-verified sensor 569 indicates so, the cam motor 559 continues to move the cam assembly 631 along the direction indicated by the arrow 735. As can be seen, the pick-up arm 641 is raised to the pick-up-arm-up level 634 so that the removable media 120 (now picked up by the pick-up arm 641) is no longer touching any portion of the interior of the media sleeve 100. The cam motor 559 deactivates when the disk-picked-up sensor 567 is actuated so as to allow the carriage motor 558 to activate and reverse the carriage assembly 621 away from the media drive 640.

At this point, the carriage assembly 621 (along with the empty media sleeve 100) is maneuvered away from the media drive 640 as actuated by the carriage motor 558 (in reverse). Once the carriage assembly 621 reaches its home position (as detected by the carriage-at-home sensor 562), the carriage motor 558 is deactivated and the cam motor 559 is again activated so that the cam assembly 631 may be moved such that the removable media 120 may be lowered to the spindle 650 (which cannot be seen in FIG. 7H because the removable media 120 is already resting on it) of the media drive 640.

As such, the cam assembly 631 continues to move along the direction indicated by the arrow 735 and the pick-up arm 641 is lowered to its lowest level, the disk-on-spindle level 635. At this point, a back edge of the cam assembly 631 disengages the detect ball 662 and the microfingers of the pick-up arm 641 release the removable media 120 so that it rests upon the spindle 650. Then, the cam assembly 631 continues to the final position where the pick-up arm 641 is raised to the pick-up-arm-parked level 636 so the removable media 120 (now released and resting on the spindle 650) may spin. Here, the cam motor 559 is deactivated as the pick-up-arm-parked sensor 568 is actuated. With the removable media 120 now on the spindle 650 of the media drive as shown in FIG. 7H, the media drive 640 may interface with the removable media 120 in a conventional manner.

FIG. 8 is a flow chart of a method for manipulating a credit card form factor having a removable media 120 and for storing data on and/or retrieving data from a removable media 120 stored in a credit card form factor according to an embodiment of the invention. Read and write routines to and from computer-readable media are well-known in the industry and will not discussed in greater detail. However, the manipulation and handling of the media, i.e., media loading, unloading, error handling, etc. is discussed in the following paragraphs.

The terminal device 400 uses a series of routines and subroutines to maneuver and use the removable media 120 as well as the media sleeve 100. In one embodiment, the controller 410 controls the steps of the terminal device in a state-machine manner. That is, the controller 410 transfers “control” to various states which wait for a particular input event (or a time-out event) in order to proceed to the next state. Thus, the following steps are described in terms of control to different states with the understanding that the controller 410 handles the majority of the states.

When a terminal device 400 is first powered on, an initialization and diagnostics state is entered at step 801. This routine checks the status of the controller 410 and the media-drive assembly 420 to ensure that all components are in proper working condition. If determined at step 803 that the initialization routine was not completed successfully, the controller 410 transfers control to an error-resolution state at step 810 and an error-resolution routine is carried out in a conventional manner to determine the cause of the problem during initialization.

If, however, the initialization routine is completed successfully, the controller 410 transfers control to a home state routine at step 805. In the home state routine, all motors are initialized to a home position as indicated by the various sensors described above. Again, if the home state routine is determined, at step 807, to have not been successfully completed, the controller 410 again transfers control to the error-resolution state at step 810. If, however, the home state routine is determined to have been successfully completed, the controller 410 transfers control to an idle state at step 820. The terminal device 400 is now ready to begin one of three sub-routines; a card-load routine, a host-state routine, or a card-unload routine.

In a typical progression of steps, after the initialization and home routines described above are completed, the terminal device 400 is be ready to accept a credit card form factor in its insert slot (as it is likely that upon start-up there is no credit card form factor or removable media already in the terminal device 400). When a user inserts a media sleeve 100 into the terminal device 400, the card-in sensor 661 detects the presence of the media sleeve 100 at step 830 and the controller 410 transfers control to the card-load state at step 831. The media sleeve 100 is then manipulated as described above with respect to FIGS. 7A-7H and the removable media 120 is extracted from the media sleeve 100 and placed on the spindle 650 of the media drive 640. If it is determined at step 832 that the card was not loaded properly, the controller 410 again transfers control to the error-resolution state at step 810. If, however, it is determined that the card-load subroutine has been completed successfully, the controller 410 returns control to the idle state at step 820 to await another subroutine.

With the removable media 120 on the spindle 650 of the media drive 640, the media drive 400 is ready to access the data stored on the removable media 120. A media-ready signal, detected at step 840 causes the controller 410 to transfer control to a host state at step 841. In the host state, various known routines for manipulating data stored on media may be executed. For example, data may be retrieved from the removable media 120 and transmitted to a remote device (not shown) for use in an application program. Once all data manipulation routines have completed, as determined at step 842, an application program running within the host state (or alternatively running on a host computer (450 of FIG. 1 with temporary control of the terminal device) generates an acknowledgment signal to indicate that the controller 410 may transfer control back to the idle state at step 820.

In the last subroutine, a card-unload state is entered at step 851 when the system determines, at step 850, that the removable media 120 that is still on the spindle 650 of the media drive 640 is to be returned to the media sleeve 100. The media sleeve 100 is then manipulated, in a reverse manner, as described above with respect to FIGS. 7A-7H and the removable media 120 is replaced inside the media sleeve 100. The media sleeve 100 is then ejected from the terminal device 400. If it is determined, at step 852, that the media sleeve 100 was not unloaded properly, the controller 410 again transfers control to the error-resolution state at step 810. If, however, it is determined that the card-unload subroutine has been completed successfully, the controller 410 returns control to the idle state at step 820 to await another subroutine.

In another embodiment of the invention, the removable media 120 may be inserted into media sleeve (not shown, although ostensibly the same as media sleeve 100) other than the media sleeve 100 in which it was originally enclosed at the beginning of the method described above. In this alternative, while the removable media 120 is on the spindle 650 of the media drive 640, the original empty media sleeve 100 is ejected from the terminal device 400, and a new empty media sleeve is inserted. Then, when the method reaches the card-unload subroutine, the removable media 120 is placed inside the new empty media sleeve and then ejected form the terminal device 400 as described above.

From the foregoing it will be appreciated that, although specific embodiments of the invention have been described herein for purposes of illustration, various modifications may be made without deviating from the spirit and scope of the invention.

We claim:

1. A credit card form factor, comprising:
a housing having an upper portion and a lower portion, the first and second portions attached to each other such that an enclosure is formed that may be accessed by manipulating at least one of the portions; and
a removable media enclosed by the housing in the enclosure, the media operable to store data in a digital format thereon.

2. The credit card form factor of claim 1 wherein the upper portion and lower portion are substantially similar to each other in a rectangular shape each having two parallel short sides and two parallel long sides.

3. The credit card form factor of claim 2 wherein each of the two parallel short sides of the upper portion is attached to the corresponding parallel short side of the lower portion.

4. The credit card form factor of claim 3 wherein one of the parallel long sides of the upper portion is attached to the corresponding long sides of the lower portion.

5. The credit card form factor of claim 4, further comprising at least one depression on at least one side of the upper portion and at least one depression on at least one corresponding side of the lower portion such that when the corresponding sides of the upper portion and lower portion are adjacent to each other, the respective depressions form a hole operable to be engaged by a pin.

6. The credit card form factor of claim 1, further comprising a protective pad disposed inside the enclosure and operable to interface with the removable media inside the enclosure.

7. The credit card form factor of claim 1 wherein the upper portion and lower portions comprise a flexible material that is biased to a closed position.

8. The credit card form factor of claim 7, further comprising at least one biasing spring disposed within the enclosure and operable to further bias one of the portions toward a flat position.

9. The credit card form factor of claim 1 wherein the removable media comprises a magnetic read/write media operable to store read/write storage data.

10. The credit card form factor of claim 1 wherein the enclosure comprises a sealed enclosure formed by a sealing interface between the upper portion and the lower portion.

11. The credit card form factor of claim 10 wherein the sealing interface comprises water tight interface.

12. The credit card form factor of claim 1, further comprising a magnetic ring disposed inside the enclosure and operable to align the removable media inside the enclosure.

13. An apparatus for engaging a credit card form factor, the apparatus comprising:
an interface operable to receive a credit card form factor having a removable media enclosed by a housing;
a media-drive assembly operable to receive the credit card form factor and operable to remove the removable media from the housing, the media-drive assembly controlled by a controller; and
a media drive operable to access data on the removable media.

14. The apparatus of claim 13, further comprising a carriage assembly for maneuvering the housing within the media-drive assembly, the carriage assembly actuated by a carriage assembly motor.

15. The apparatus of claim 13, further comprising a spreader operable to interface the housing such that an upper portion of the housing is bent upward and a lower portion of the housing is bent downward so that the removable media may be retrieved from an opening created by bending the portions of the housing.

16. The apparatus of claim 15, further comprising a pick-up arm assembly operable to engage the removable media via the opening created by the spreader.

17. The apparatus of claim 16 wherein the pick-up arm further comprises microfingers operable to engage a hub disposed on the removable media, the microfingers actuated by a detent ball mechanism.

18. The apparatus of claim 16 wherein the pick-up arm is actuated by a cam assembly, the cam assembly actuated by a cam assembly motor.

19. The apparatus of claim 13 wherein the interface comprises an insert slot adjacent to a roller mechanism, the roller mechanism operable to engage the housing of the credit card form factor and actuated by a roller motor.

20. A system for retrieving data from a media, the system comprising:
a removable media enclosed by a credit card form factor; and
a terminal device including:
an interface operable to receive the credit card form factor;
an apparatus operable to remove the removable media from the credit card form factor; and
a media drive operable to retrieve data from the removable media.

21. The system of claim 20, further comprising:
a communication component operable to transmit the retrieved data over a network; and
a host connected to the network, the host operable to execute an application thereon for manipulating the retrieve data transmitted to the network.

22. The system of claim 21 wherein the application is a financial application.

23. The system of claim 21 wherein the application is a medical records application.

24. The system of claim 21 wherein the application is a personal information application.

25. The system of claim 21, further comprising server computer connected to the network and operable to store the received data that is transmitted to the host computer.

26. A method for manipulating data stored on a media, the data comprising:
removing a removable media enclosed by a credit card form factor; the removable media having data stored thereon;
maneuvering the removable media to a media drive operable to perform read and write functions on the removable media; and
manipulating the data stored on the removable media.

27. The method of claim 26 wherein the manipulating the data comprises reading the data.

28. The method of claim 26 wherein the manipulating the data comprises writing new data to be stored on the removable media.

29. The method of claim 26, further comprising:
retrieving data from the removable media; and
transmitting the retrieved data to an application.

30. The method of claim 29 wherein the transmitting further comprises transmitting the retrieved data over a network to a host computer, the host computer hosting the application.

31. The method of claim 29, further comprising:
transmitting new data from the host computer to the media drive via the network; and
writing the new data to the removable media.

32. The method of claim 26 further comprising replacing the removable media back into the credit card form factor.

33. The method of claim 26 further comprising placing the removable media into a new credit card form factor.

34. A method for manipulating a media, the method comprising:
receiving a credit card form factor having a removable media enclosed therein at an interface point of a terminal device, the removable media having data stored thereon;
removing the removable media from the credit card form factor; and
maneuvering the removed removable media to a media drive operable to perform read and write functions on the removable media.

35. The method of claim 34, further comprising reading the data from the removable media.

36. The method of claim 34, further comprising writing new data to the removable media.

37. The method of claim 34, further comprising:
retrieving data the data from the removable media; and
transmitting the retrieved data to an application program.

38. A method of manufacturing an article, the method comprising:
forming a credit card form factor having a first portion and a second portion, the first and second portions attached to each other such that an enclosure is formed that may be accessed by manipulating at least one of the portions; and
enclosing a removable media in the credit card form factor, the media operable to store data in a digital format thereon.

39. The method of claim 38 wherein the forming further comprises forming the upper portion and lower portion substantially similar to each other in a rectangular shape each having two parallel short sides and two parallel long sides.

40. The method of claim 39 wherein the forming further comprises attaching each of the two parallel short sides of the upper portion to the corresponding parallel short side of the lower portion.

41. The method of claim 40 wherein the forming further comprises attaching one of the parallel long sides of the upper portion to the corresponding long sides of the lower portion.

42. The method of claim 40 wherein the forming further comprises forming at least one depression on at least one long side of the upper portion and at least one depression on at least one long side of the upper portion such that when the corresponding long sides of the upper portion and lower portion are adjacent to each other, the respective depressions form a hole operable to be engaged by a pin.

43. A system, comprising:
a terminal device including:
an interface operable to receive a credit card form factor having a removable media enclosed by a housing;
a media-drive assembly operable to receive the credit card form factor and operable to remove the removable media from the housing, the media- drive assembly controlled by a controller;
a media drive operable to access data on the removable media; and
a transmitter operable to transmit accessed data; and
a host computer having an application program running thereon, the host computer operable to receive the transmitted data from the transmitter.

44. The system of claim 43, further comprising a display device connected to the host computer and operable to display the received information.

45. The system of claim 43, further comprising:
an input device connected to the host computer and operable to receive input from a user; and
a second transmitter connected to the host computer operable to transmit the input to the terminal device.

46. The system of claim 45 wherein the terminal device is further operable to store the received input from the second transmitter on the removable media.

47. The system of claim 45 wherein the input device is an alpha-numeric keypad.
